(19) United States
(12) Patent Application Publication
(10) Pub. No.: US 2025/0117275 A1
(43) Pub. Date: Apr. 10, 2025

(54) MICROCONTROLLER CIRCUIT, ANALYSIS SYSTEM, AND CONTROL METHOD

(71) Applicant: Nuvoton Technology Corporation, Hsinchu Science Park (TW)

(72) Inventors: Ta-Chin CHIU, Hsinchu Science Park (TW); Chieh-Sheng TU, Hsinchu Science Park (TW)

(21) Appl. No.: 18/905,302

(22) Filed: Oct. 3, 2024

(30) Foreign Application Priority Data
Oct. 6, 2023 (TW) 112138387

(51) Int. Cl. G06F 11/07; G06F 11/14

(52) U.S. Cl. CPC G06F 11/076; G06F 11/1441

(57) ABSTRACT

A microcontroller circuit including a detection circuit, a storage circuit, an error counter circuit, a comparison circuit, and a processing circuit is provided. The detection circuit enables a trigger signal and outputs error information in response to the occurrence of an error event. The storage circuit stores the error information. The error counter circuit adjusts the count value according to the number of times that the trigger signal is enabled by the detection circuit. The comparison circuit enables an interruption signal in response to the count value reaching a threshold value. The processing circuit performs a specific operation according to the interruption signal.

### CROSS REFERENCE TO RELATED APPLICATIONS

This Application claims priority of Taiwan Patent Application No. 112138387, filed on Oct. 6, 2023, the entirety of which is incorporated by reference herein.

### BACKGROUND OF THE INVENTION

### Field of the Invention

The present invention relates to a microcontroller circuit, and, in particular, to a microcontroller circuit that counts the occurrences of errors.

### Description of the Related Art

A watchdog timer (WDT) or a brownout detection (BOD) circuit may be used to reset a system to solve unexpected errors. Although the system can still work normally, the system may again be in an error state within a short period of time, thereby increasing the risk of product malfunctions.

### BRIEF SUMMARY OF THE INVENTION

In accordance with an embodiment of the disclosure, a microcontroller circuit comprises a detection circuit, a storage circuit, an error counter circuit, a comparison circuit, and a processing circuit. The detection circuit enables a trigger signal and outputs error information in response to the occurrence of an error event. The storage circuit stores the error information. The error counter circuit adjusts the count value according to the number of times that the trigger signal is enabled by the detection circuit. The comparison circuit enables an interruption signal in response to the count value reaching a threshold value. The processing circuit performs a specific operation according to the interruption signal.

In accordance with another embodiment of the disclosure, an analysis system comprises a measuring instrument and a microcontroller circuit. The measuring instrument comprises a debug tool. The microcontroller circuit is coupled to the measuring instrument and comprises a detection circuit, a debug interface, a storage circuit, an error counter circuit, a comparison circuit, and a processing circuit. The detection circuit comprises a first output terminal and a second terminal. The detection circuit outputs a trigger signal via the first output terminal and outputs error information via the second output terminal in response to the occurrence of an error event. The debug interface is coupled between the first output terminal and the measuring instrument. The storage circuit is coupled to the first and second output terminals and records the error information. The error counter circuit is coupled to the first output terminal. The error counter circuit adjusts the count value according to the trigger signal. The comparison circuit enables an interruption signal in response to the count value reaching a threshold value. The processing circuit performs a reset operation according to the interruption signal.

A control applied in a microcontroller circuit is provided. An exemplary embodiment of the control method is described in the following paragraph. A determination is made as to whether an error event has occurred. In response to the occurrence of an error event, the count value is adjusted and error information is generated. The error information is recorded in a storage circuit. In response to the count value reaching a threshold value, a processing circuit is directed to perform a reset operation. In response to the processing circuit finishing the reset operation, the error information is provided to the processing circuit.

Control methods may be practiced by the systems which have hardware or firmware capable of performing particular functions and may take the form of program code embodied in a tangible media. When the program code is loaded into and executed by an electronic device, a processor, a computer or a machine, the electronic device, the processor, the computer or the machine becomes a microcontroller circuit and an analysis system for practicing the disclosed method.

### BRIEF DESCRIPTION OF THE DRAWINGS

The present invention can be more fully understood by reading the subsequent detailed description and examples with references made to the accompanying drawings, wherein:

FIG. 1 is a schematic diagram of an exemplary embodiment of an analysis system according to various aspects of the present disclosure.

FIG. 2A is a schematic diagram of an exemplary embodiment of a microcontroller circuit according to various aspects of the present disclosure.

FIG. 2B is a schematic diagram of another exemplary embodiment of the microcontroller circuit according to various aspects of the present disclosure.

FIG. 2C is a schematic diagram of another exemplary embodiment of the microcontroller circuit according to various aspects of the present disclosure.

FIG. 3 is a flowchart of a control method in accordance with an embodiment of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

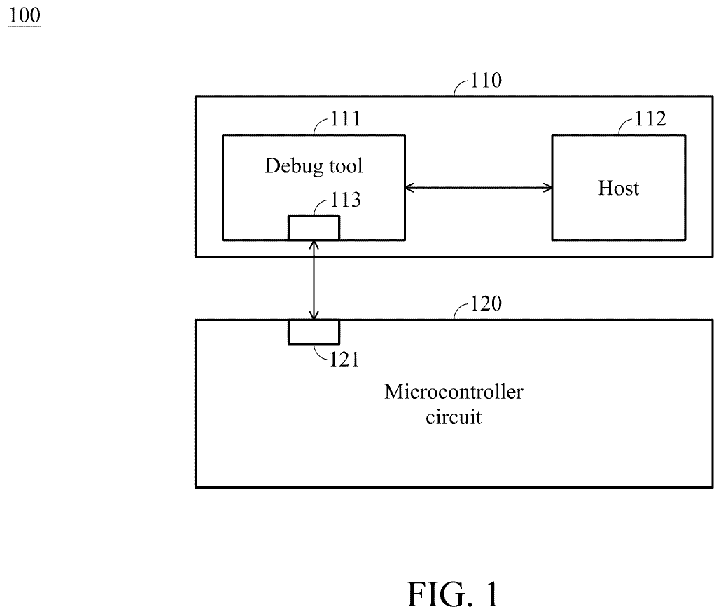

FIG. 1 is a schematic diagram of an exemplary embodiment of an analysis system according to various aspects of the present disclosure. The analysis system 100 comprises a measuring instrument 110 and a microcontroller circuit 120. The measuring instrument 110 comprises a debug tool 111 and a host 112. The host 112 measures the microcontroller circuit 120 via the debug tool 111 and executes a debug operation in the microcontroller circuit 120. The kind of host 112 is not limited in the present disclosure. In one embodiment, the host 112 can be a computer/electronic device such as a personal computer (PC), a tablet or a mobile phone.

The debug tool 111 comprises a debug interface 113. The debug interface 113 is configured to be coupled to the microcontroller circuit 120. In one embodiment, the debug interface 113 is a serial wire debug (SWD) interface. The debug tool 111 communicates with the microcontroller circuit 120 via the debug interface 113. The kind of debug tool 111 is not limited in the present disclosure. In one embodiment, the debug tool 111 may be a joint test action group (JTAG) tool or an in-circuit emulator (ICE).

The microcontroller circuit 120 is coupled to the measuring instrument 110. In one embodiment, the microcontroller circuit 120 comprises a debug interface 121. The kind of debug interface 121 is the same as the kind of debug interface 113. For example, the debug interface 121 may be a SWD interface. In this embodiment, the microcontroller circuit 120 collects information and times of errors. The microcontroller circuit 120 generates and displays a health level according to the collected error information. In one embodiment, when the health level of the microcontroller circuit 120 is not good, the microcontroller circuit 120 may perform an interruption operation or a reset operation according to the hardware settings, and automatically enter the error analysis mode. In the error analysis mode, the microcontroller circuit 120 analyzes the collected error information. The microcontroller circuit 120 may issue a warning message or perform a debug operation to protect the entire analysis system.

In other embodiments, each when an error event occurs in the microcontroller circuit 120, the microcontroller circuit 120 notifies the measuring instrument 110 via the debug interface 121. The measuring instrument 110 may collect error information or executes a debug operation for the microcontroller circuit 120 according to the error information collected by the microcontroller circuit 120. Therefore, the designer can obtain the health level of the microcontroller circuit 120 and can further decide whether to spend time solving unexpected errors. For example, the designer may reset the microcontroller circuit 120 to direct the microcontroller circuit 120 to enter a safe state.

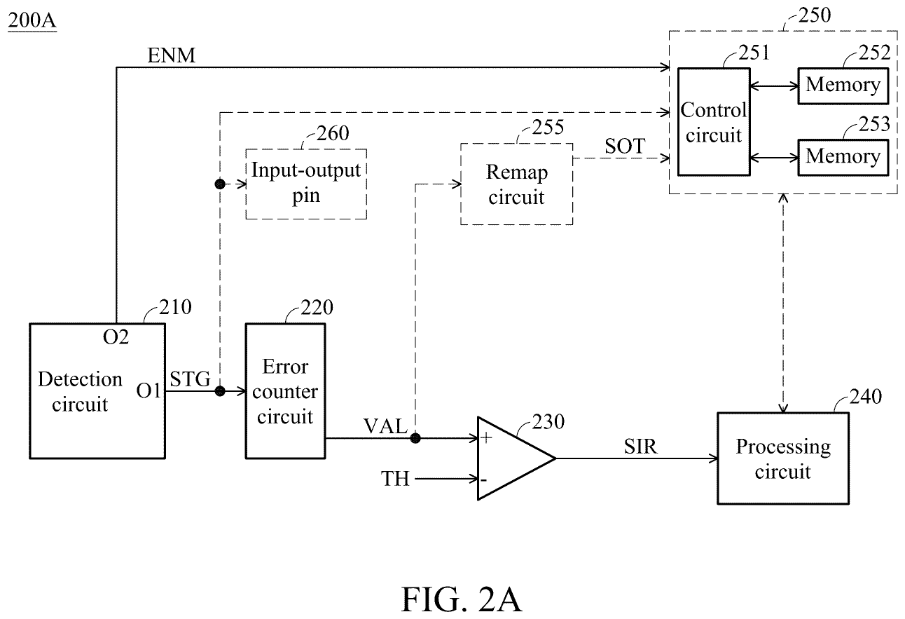

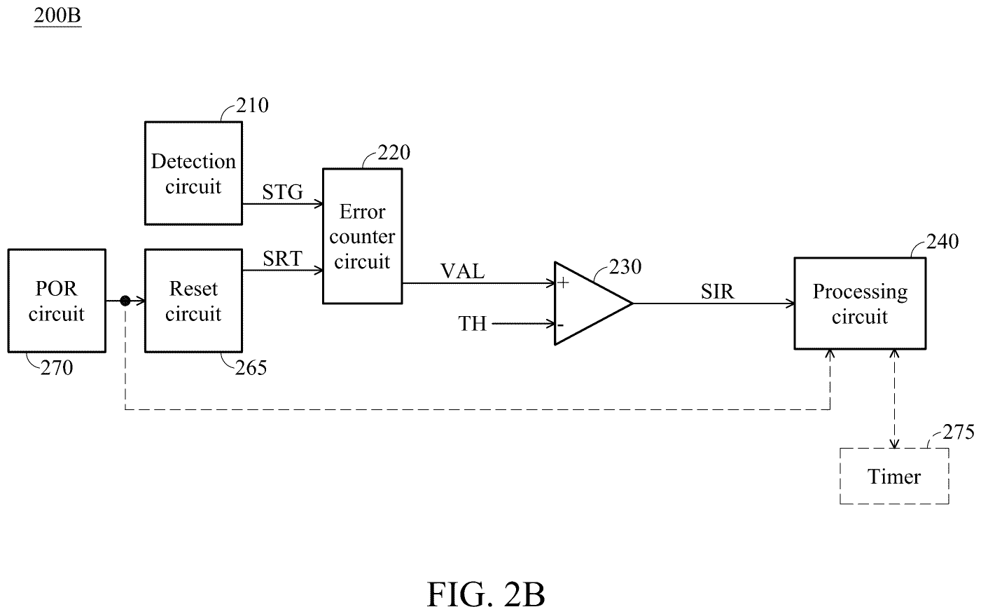

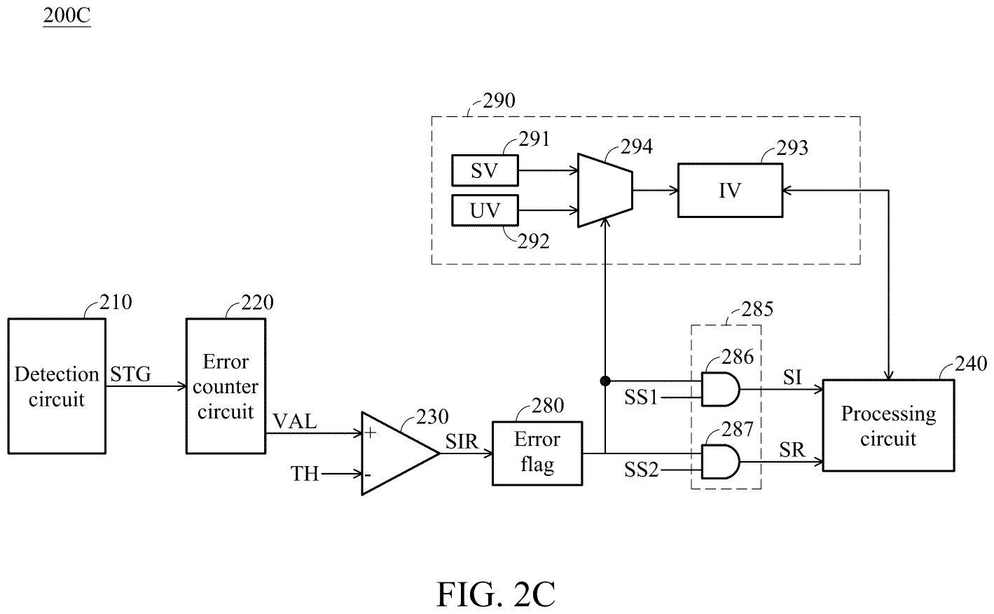

FIG. 2A is a schematic diagram of an exemplary embodiment of the microcontroller circuit according to various aspects of the present disclosure. The microcontroller circuit 200A comprises a detection circuit 210, an error counter circuit 220, a comparison circuit 230, and a processing circuit 240. In one embodiment, the microcontroller circuit 200A is integrated into a control chip. In this case, the microcontroller circuit 200A may serve as a microcontroller unit (MCU).

The detection circuit 210 is configured to detect whether an error event occurs. When an error event occurs, the detection circuit 210 enables a trigger signal STG. The structure of detection circuit 210 is not limited in the present disclosure. Any circuit with a detection function can be used as the detection circuit 210. In one embodiment, the detection circuit 210 comprises an output terminal O1. The output terminal O1 is configured to output the trigger signal STG.

The error counter circuit 220 adjusts the count value VAL according to the number of times that the trigger signal STG is enabled by the detection circuit 210. In one embodiment, the error counter circuit 220 is coupled to the output terminal O1 and adjusts the count value VAL according to the trigger signal STG. For example, the error counter circuit 220 adds 1 to the count value each time the trigger signal STG is enabled by the detection circuit 210. The structure of error counter circuit 220 is not limited in the present disclosure. In one embodiment, the error counter circuit 220 comprises a counter.

The comparison circuit 230 compares the count value VAL and a threshold value TH. When the count value VAL reaches the threshold value TH, it means that the number of error events is larger. Therefore, the comparison circuit 230 enables an interruption signal SIR. In one embodiment, when the interruption signal SIR is at a high level, it means that the comparison circuit 230 enables the interruption signal SIR. However, when the count value VAL does not reach the threshold value TH, the comparison circuit 230 does not enable the interruption signal SIR. At this time, the comparison circuit 230 may set the interruption signal SIR to a low level.

The structure of comparison circuit 230 is not limited in the present disclosure. In one embodiment, the comparison circuit 230 comprises a comparator to determine whether the count value VAL reaches the threshold value TH. The source of providing the threshold value TH is not limited in the present disclosure. The threshold value TH may store a register. In one embodiment, the processing circuit 240 writes the threshold value TH in the register.

The processing circuit 240 performs a specific operation according to the interruption signal SIR. For example, when the interruption signal SIR is enabled, it means that the number of error events is large. Therefore, the processing circuit 240 may perform a specific operation. The type of specific operation is not limited in the present disclosure. In one embodiment, the specific operation is performed to send a warning information to notify the user that the operation of the microcontroller circuit 200A is abnormal. The type of warning information is not limited in the present disclosure. In one embodiment, the warning information may be an image or a sound.

In other embodiments, when the number of error events is large, the specific operation performed by the processing circuit 240 is an interruption operation or a reset operation. After finishing the reset operation, the processing circuit 240 may automatically enter the error analysis mode. In the error analysis mode, processing circuit 240 the processing circuit 240 may notify an external measuring instrument. Therefore, the external measuring instrument starts to measure the microcontroller circuit 200A to protect the operation of the microcontroller circuit 200A.

In other embodiments, the microcontroller circuit 200A further comprises a storage circuit 250. The storage circuit 250 records the error information ENM. The processing circuit 240 analyzes the cause of the error event according to the error information ENM recorded by the storage circuit 250. The source of the error information ENM is not limited in the present disclosure. In one embodiment, the error information ENM is provided by the detection circuit 210. In one embodiment, the detection circuit 210 comprises an output terminal O2. The output terminal O2 is configured to output the error information ENM. The detection circuit 210 sends error information ENM with different characteristics according to different error events.

For example, when the detection circuit 210 detects an abnormal operation of a pulse width modulation (PWM) circuit, the error information ENM sent by the detection circuit 210 has a first coded value (such as 0). When the detection circuit 210 detects a specific current abnormality, the error information ENM sent by the detection circuit 210 has a second coded value (such as 1). When the detection circuit 210 detects a specific voltage abnormality, the error information ENM sent by the detection circuit 210 has a third coded value (such as 2).

The type of error events is not limited in the present disclosure. In one embodiment, the error event may include a hardware fault, a memory parity abnormality, a cyclic redundancy check (CRC) abnormality, an abnormal reset, etc. The detection circuit 210 sends error information ENM with different electrical characteristics for different types of error events.

The processing circuit 240 can determine the error state of the micro control circuit 200A according to the error information ENM recorded by the storage circuit 250 to protect the microcontroller circuit 200A. For example, when the interruption signal SIR is enabled, it means that the number of error events is large. The processing circuit 240 enters the error analysis mode. In the error analysis mode, the processing circuit 240 reads the error information ENM stored in the storage circuit 250 to determine the error states of the error events. For example, twenty abnormal resets occur within one day.

In another embodiment, the microcontroller circuit 200A further comprises a debug interface (not shown). In this case, an external measuring instrument may use the debug interface to read the error information ENM recorded by the storage circuit 250 and analyzes the error information ENM to determine the error state of the microcontroller circuit 200A.

In this embodiment, the storage circuit 250 is coupled to the output terminals O1 and O2. Each when the detection circuit 210 enables the trigger signal STG, the storage circuit 250 records the error information ENM. In some embodiment, the error information ENM may indicate the types of the error events, such as a current abnormality or a voltage abnormality. In other embodiment, the error information ENM further comprises detailed information, such as the current is abnormal and the current value is 3 A, or the time when the error occurred, etc.

The structure of storage circuit 250 is not limited in the present disclosure. In one embodiment, the storage circuit 250 comprises a control circuit 251 and a memory 252. The control circuit 251 stores the error information ENM in a memory block of the memory 252. The kind of memory 252 is not limited in the present disclosure. In one embodiment, the memory 252 may be a non-volatile memory or a volatile memory. In other embodiments, the storage circuit 250 further comprises a memory 253. In this case, the control circuit 251 stores the error information ENM in the memory 252 or 253 according to a control signal SOT. In some embodiments, the memory 253 may be a non-volatile memory or a volatile memory.

In some embodiments, the microcontroller circuit 200A further comprises a remap circuit 255. The remap circuit 255 generates the control signal SOT according to the count value VAL. In this case, the control circuit 251 assigns a storage address according to the control signal SOT and writes the error information ENM in the memory corresponding to the storage address.

In other embodiments, the microcontroller circuit 200A further comprises an input-output pin 260. The input-output pin 260 is coupled to the output terminal O1 to receive the trigger signal STG. When an error event occurs, the detection circuit210 enables the trigger signal STG. Therefore, the voltage level of the input-output pin 260 is a specific level, such as a high level. In one embodiment, the input-output pin 260 is coupled to a debug interface (e.g., the debug interface 121 shown in FIG. 1). In this case, when an error event occurs in the microcontroller circuit 200A, a specific pin (which is coupled to the input-output pin 260) of the debug interface is at a specific level. Therefore, the measuring instrument 110 starts monitoring the operation and the setting of the microcontroller circuit 200A to find out the cause of the error event. The number of input-output pins is not limited in the present disclosure. In other embodiments, the detection circuit 210 sets the voltage levels of different input-output pins to a specific level according to different error events.

FIG. 2B is a schematic diagram of another exemplary embodiment of the microcontroller circuit according to various aspects of the present disclosure. FIG. 2B is similar to FIG. 2A except that the microcontroller circuit 200B further comprises a reset circuit 265. When the reset circuit 265 is triggered, the reset circuit 265 sends a reset signal SRT to reset the error counter circuit 220. When the error counter circuit 220 is reset, the count value VAL is equal to a predetermined value, such as 0.

In some embodiments, the microcontroller circuit 200B further comprises a power-on reset (POR) circuit 270. The POR circuit 270 is configured to detect an operation voltage (now shown). When the operation voltage reaches a target value, the POR circuit 270 triggers the reset circuit 265 so that the reset circuit 265 sends the reset signal SRT. In one embodiment, the operation voltage is the operation voltage of the microcontroller circuit 200B.

In other embodiments, the processing circuit 240 triggers the reset circuit 265 at fixed time intervals. In this case, the processing circuit 240 triggers the reset circuit 265 according to the counting result of the timer 275. For example, when the count value of the timer 275 reaches a predetermined value, the processing circuit 240 triggers the reset circuit 265 and resets the timer 275 so that the timer 275 re-counts. Therefore, the processing circuit 240 can count the number of errors in a fixed period according to the error information ENM recorded by the storage circuit 250. In another embodiment, the processing circuit 240 executes program codes stored in a memory (not shown). When the processing circuit 240 executes a specific program code, the processing circuit 240 triggers the reset circuit 265.

In some embodiments, at least one of the storage circuit 250 and the input-output pin 260 of FIG. 2A may be integrated into the microcontroller circuit 200B. In another embodiment, both of the storage circuit 250 and the remap circuit 255 of FIG. 2A may be integrated into the microcontroller circuit 200B.

FIG. 2C is a schematic diagram of another exemplary embodiment of the microcontroller circuit according to various aspects of the present disclosure. FIG. 2C is similar to FIG. 2A except that the microcontroller circuit 200C of FIG. 2C further comprises an error flag 280. The error flag 280 is coupled to the comparison circuit 230 to store the interruption signal SIR. In one embodiment, when the count value VAL reaches the threshold value TH, the comparison circuit 230 enables the interruption signal SIR. At this time, the error flag 280 may store a specific value, such as 1. When the count value VAL does not reach the threshold value TH, the comparison circuit 230 does not enable the interruption signal SIR. At this time, the value of the error flag 208 does not the specific value. The processing circuit 240 operates according to the value of the error flag 280. For example, when the value of the error flag is the specific value, it means that the number of error events is large. Therefore, the processing circuit 240 performs a specific operation, such as an interruption operation or a reset operation. When the value of the error flag 280 is not equal to the specific value, it means that the number of error events is small. Therefore, the processing circuit 240 continues the operation being performed.

In some embodiments, the microcontroller circuit 200C further comprises a logic circuit 285. The logic circuit 285 receives setting signals SS1 and SS2 and is coupled between the error flag 280 and the processing circuit 240. When the setting signal SS1 is enabled, it means that the number of error events is large and the processing circuit 240 needs to perform an interruption operation. When the setting signal SS1 does not be enabled, the processing circuit 240 does not need to perform the interrupt operation even if the number of error events is large. Additionally, when the setting signal SS2 is enabled, it means that the number of error events is large and the processing circuit 240 needs to perform a reset operation. When the setting signal SS2 does not be enabled, the processing circuit 240 does not need to perform the reset operation even if the number of error events is large.

In this embodiment, the logic circuit 285 comprises AND gates 286 and 287. The AND gate 286 is coupled to the error flag 280 and receives the setting signal SS1. When the value of the error flag 280 is equal to the specific value and the setting signal SS1 is enabled, the AND gate 286 enables an interruption signal SI. Therefore, the processing circuit 240 executes an interruption operation. When the value of the error flag 280 is not equal to the specific value or the setting signal SS1 is not enabled, the AND gate 286 does not enable the interruption signal SI.

The AND gate 287 is coupled to the error flag 280 and receives the setting signal SS2. When the value of the error flag 280 is equal to the specific value and the setting signal SS2 is enabled, the AND gate 287 enables a reset signal SR. Therefore, the processing circuit 240 executes a reset operation. When the value of the error flag 280 is not equal to the specific value or the setting signal SS2 is not enabled, the AND gate 287 does not enable the reset signal SR.

In some embodiments, the microcontroller circuit 200C further comprises an interruption circuit 290. When the value of the error flag 280 is equal to the specific value, the interruption circuit 290 uses a safety vector SV as an interruption vector IV. When the value of the error flag 280 is not equal to the specific value, the interruption circuit 290 uses a user vector UV as the interruption vector IV.

The structure of the interruption circuit 290 is not limited in the present disclosure. In one embodiment, the interruption circuit 290 comprises registers 291˜293 and a selector 294. The register 291 stores the safety vector SV. The register 292 stores the user vector UV. The selector 294 uses the safety vector SV or the user vector UV as the interruption vector IV according to the value of the error flag 280. The selector 294 stores the interruption vector IV in the register 293.

After finishing the reset operation, the processing circuit 240 executes the program code corresponding to the interruption vector IV. In some embodiments, when the selector 294 uses the safety vector SV as the interruption vector IV, after the processing circuit 240 executes the program code corresponding to the interruption vector IV, the processing circuit 240 enters the error analysis mode to analyze the cause of the error event.

In other embodiments, at least one of the storage circuit 250 and the input-output pin 260 of FIG. 2A may be integrated into the microcontroller circuit 200C. In another embodiment, both of the storage circuit 250 and the remap circuit 255 of FIG. 2A may be integrated into the microcontroller circuit 200C. Additionally, the reset circuit 26, the POR circuit 270 and the timer 275 of FIG. 2A may be integrated into the microcontroller circuit 200C.

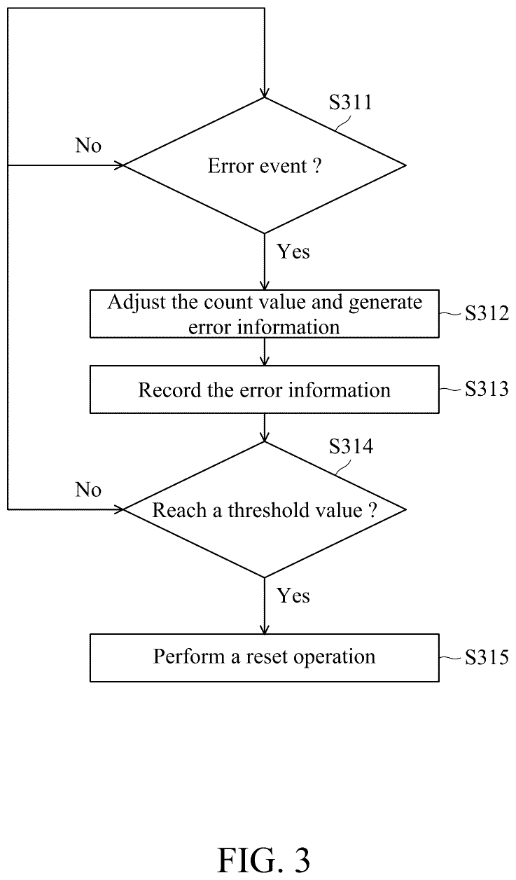

FIG. 3 is a flowchart of a control method in accordance with an embodiment of the present disclosure. Control methods may take the form of a program code. When the program code is loaded into and executed by a machine, the machine thereby becomes a microcontroller circuit and an analysis system for practicing the methods.

First, a determination is made as to whether an error event has occurred (step S311). The types of error events are not limited in the present disclosure. In one embodiment, the microcontroller circuit comprises a plurality of detection circuits. Each of the detection circuits detects electrical characteristics of different objects. When an electrical characteristic does not match an expectation state, it means that an error event occurs. Therefore, the detection circuit may enable a trigger signal. Therefore, by determining whether the trigger signal is enabled, it can be determined whether or not an error event has occurred.

When an error event occurs, the count value is adjusted and error information is generated (step S312). In one embodiment, the error information comprises a field to record the type of error event. In one embodiment, the error information includes many fields, respectively indicating the type of error event (such as a current abnormality, or a voltage abnormality), the degree of abnormality (such as an abnormal current is 3 A or an abnormal voltage is 1V), or the time point when the error event occurs.

In some embodiments, when an operation voltage reaches a target value, a POR circuit resets the count value so that it is equal to an initial value, such as 0. In another embodiment, the microcontroller circuit resets the count value at fixed time intervals. In other embodiments, when the microcontroller circuit executes a reset program code, the microcontroller circuit resets the count value.

The error information is records in a storage circuit (step S313). In one embodiment, all error information is recorded in the same memory. In another embodiment, different types of error information may be stored in different memories. For example, important error information may be stored in a non-volatile memory, and unimportant error information may be stored in a volatile memory.

A determination is made as to whether the count value reaches a threshold value (step S314). When the count value reaches the threshold value, it means that the number of errors is large. Therefore, a processing circuit is directed to perform a reset operation (step S315). In one embodiment, after finishing the reset operation, the processing circuit enters the error analysis mode. In the error analysis mode, the processing circuit analyzes the error information recorded in step S313.

In other embodiments, the error information recorded in step S313 may be provided to a measuring instrument. In this case, each when an error event occurs, the measuring instrument is notified and corresponding error information is provided to the measuring instrument. The measuring instrument analyzes the error information to provide an analysis report. Therefore, the users can know the problem according to the analysis report.

It will be understood that when an element or layer is referred to as being “coupled to” another element or layer, it can be directly on, connected or coupled to the other element or layer or intervening elements or layers may be present. In contrast, when an element or layer is referred to as be “directly coupled to” another element or layer, there are no intervening elements or layers present. Additionally, “enable” shall mean changing the state of a Boolean signal. Boolean signals may be enabled high or with a higher voltage, and Boolean signals may be enabled low or with a lower voltage, at the discretion of the circuit designer. Similarly, “disable” shall mean changing the state of the Boolean signal to a voltage level opposite the enabled state.

Control methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a microcontroller circuit and an analysis system for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a microcontroller circuit and an analysis system for practicing the disclosed methods. When implemented on a general-purpose processor, the program code combines with the processor to provide a unique apparatus that operates analogously to application-specific logic circuits.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another. In the following claims, the terms “first,” “second,” etc. are used merely as labels, and are not intended to impose numerical requirements on their objects.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microcontroller circuit comprising:
a detection circuit enabling a trigger signal and outputting error information in response to an occurrence of an error event;
a storage circuit storing the error information;
an error counter circuit adjusting a count value according to the number of times that the trigger signal is enabled by the detection circuit;
a comparison circuit enabling an interruption signal in response to the count value reaching a threshold value; and
a processing circuit performing a specific operation according to the interruption signal.

2. The microcontroller circuit as claimed in claim 1, wherein the specific operation is a reset operation.

3. The microcontroller circuit as claimed in claim 2, wherein after finishing the reset operation, the processing circuit enters an error analysis mode to analyze the error information stored in the storage circuit.

4. The microcontroller circuit as claimed in claim 2, further comprising:
an error flag coupled to the comparison circuit,
wherein:
in response to the count value reaching the threshold value, the comparison circuit sets the value of the error flag to a specific value, and
in response to the value of the error flag being the specific value, the processing circuit performs the specific operation.

5. The microcontroller circuit as claimed in claim 4, further comprising:
an interruption circuit providing an interruption vector in response to the value of the error flag being the specific value,
wherein after finishing the reset operation, the processing circuit performs program codes corresponding to the interruption vector.

6. The microcontroller circuit as claimed in claim 1, further comprising:
an input-output pin,
wherein:
in response to the occurrence of the error event, the detection circuit sets a voltage level of the input-output pin to a specific level.

7. The microcontroller circuit as claimed in claim 1, further comprising:
a remap circuit generating a control signal according to the count value,
wherein the storage circuit stores the error information according to the control signal.

8. The microcontroller circuit as claimed in claim 1, further comprising:
a reset circuit configured to reset the count value.

9. The microcontroller circuit as claimed in claim 8, wherein the processing circuit triggers the reset circuit at fixed time intervals.

10. The microcontroller circuit as claimed in claim 8, further comprising:
a power-on reset circuit configured to trigger the reset circuit.

11. An analysis system, comprising:
a measuring instrument comprising a debug tool; and
a microcontroller circuit coupled to the measuring instrument and comprising:
a detection circuit comprising a first output terminal and a second terminal, wherein the detection circuit outputs a trigger signal via the first output terminal and outputs error information via the second output terminal in response to the occurrence of an error event;
a debug interface coupled between the first output terminal and the measuring instrument;
a storage circuit coupled to the first and second output terminals and recording the error information;
an error counter circuit coupled to the first output terminal, wherein the error counter circuit adjusts the count value according to the trigger signal;
a comparison circuit enabling an interruption signal in response to the count value reaching a threshold value; and
a processing circuit performing a reset operation according to the interruption signal.

12. The analysis system as claimed in claim 11, wherein in response to the detection circuit enabling the trigger signal, the measuring instrument reads the error information from the storage circuit.

13. The analysis system as claimed in claim 11, wherein the debug interface is a serial wire debug (SWD) interface.

14. The analysis system as claimed in claim 11, wherein the microcontroller circuit further comprises:
a remap circuit generating a control signal according to the count value,
wherein the storage circuit stores the error information according to the control signal.

15. The analysis system as claimed in claim 14, wherein the storage circuit comprises:
a non-volatile memory;
a volatile memory; and
a memory controller storing the error information in the non-volatile memory or the volatile memory according to the control signal.

16. The analysis system as claimed in claim 11, wherein the microcontroller circuit further comprises:
an interruption circuit providing an interruption vector according to the interruption signal,
wherein after finishing the reset operation, the processing circuit performs program codes corresponding to the interruption vector.

17. The analysis system as claimed in claim 11, wherein the microcontroller circuit further comprises:
a reset circuit configured to reset the count value.

18. The analysis system as claimed in claim 17, wherein the processing circuit triggers the reset circuit at fixed time intervals.

19. A control method applied in a microcontroller circuit, comprising:
determining whether an error event occurs;
adjusting the count value and generating error information in response to the error event occurring;
recording the error information in a storage circuit;
directing a processing circuit to perform a reset operation in response to the count value reaching a threshold value; and
providing the error information to the processing circuit in response to the processing circuit finishing the reset operation.

20. The control method as claimed in claim 19, further comprising:
notifying a measuring instrument and providing the error information to the measuring instrument each time the error event occurs,
wherein the measuring instrument analyzes the error information to provide an analysis report.
